(19) United States
(12) Patent Application Publication
(10) Pub. No.: US 2022/0278722 A1
(43) Pub. Date: Sep. 1, 2022

(54) Optimizations To LTE-NR Inter-RAT Mobility

(71) Applicant: Telefonaktiebolaget LM Ericsson (publ), Stockholm (SE)

(72) Inventors: Jagadeesh Arunachalam, Malmö (SE); Jens Jansson, Eslöv (SE); Magnus Jönsson, Limhamn (SE)

(21) Appl. No.: 17/632,276

(22) PCT Filed: Aug. 7, 2019
(86) PCT No.: PCT/EP2019/071213

§ 371 Date: Feb. 2, 2022

(51) Int. Cl. H04B 7/06; H04W 36/00; H04W 16/28; H04W 36/14; H04W 76/15

(52) U.S. Cl. CPC H04B 7/0617; H04W 36/0055; H04W 16/28; H04W 36/14; H04W 76/15; H04W 88/06

(57) ABSTRACT

Beamforming characteristics determined for a master RAT are reused to form the beam(s) for a different, secondary RAT when communications using the second RAT becomes desirable, e.g., during handover or for dual connectivity scenarios, when an antenna arrangement for the first RAT is close enough to the antenna arrangement for the second RAT. When these antenna arrangements are “close enough,” the assumption is that the beamforming characteristics for the first RAT are a reasonable approximation of the beamforming characteristics that would be determined for the second RAT. By reusing the beamforming characteristics, the solution presented herein provides the efficiency and directionality provided by dynamic beamforming while avoiding the delay typically associated with traditional beamforming solutions.

### TECHNICAL FIELD

The solution presented herein generally relates to wireless communications, and more particularly relates to RAT-specific beamforming in wireless communications.

### BACKGROUND

As new wireless technologies are developed for a limited number of resources, such new technologies may be developed to complement and/or supplement existing wireless technologies. For example, a first version of the New Radio (NR) standard that complements 4^{th} Generation Long Term Evolution (4G LTE) was released with the 3^{rd} Generation Partnership Project (3GPP) Release 15 specification. This NR technology will coexist with LTE, and Mid-band deployments will use the same frequency range that LTE supports.

3GPP release 15, e.g., 3GPP TS 38.300NR and NG-RAN overall description, supports handover from Evolved Universal Mobile Telecommunications System (UMTS) Terrestrial Radio Access Network (EUTRAN) to NR. Further, 3GPP TS 37.340 NR multi connectivity also introduces an Inter-Radio Access Technology (Inter-RAT) mobility procedure called EUTRA NR Dual Connectivity (EN-DC). EN-DC is a feature where a Universal Equipment (UE) is configured to connect to both NR and to LTE radio links simultaneously. For example, such EN-DC can be thought of as carrier aggregation, but between two RATs, where the UE has a single control plane connected to the core network via EUTRAN, but has a user plane connected to both EUTRAN and NR.

In addition, NR supports use of multi-antenna systems and Multiple Input, Multiple Output (MIMO). The data and control channels to the UE use beams formed using beamforming to provide directionality and capacity gain. In both NR and EUTRA systems, two kinds of beamforming currently exist: common channel beamforming and UE-specific beamforming. With common channel beamforming, the beams span the entire planned coverage area, where the coverage area is typically one of Macro, Highrise, or Hotspot. In this case, static beamforming characteristics are used in all antenna elements so that the beams together cover the entire planned coverage area. Common channel beamforming enables quick beamforming, but is not directional or efficient.

With UE-specific beamforming, the beams (radiation pattern) are directed towards individual UEs in the downlink, and from the UEs to the node in the Uplink. In Time Division Duplex (TDD) systems, the UE is configured to send a Sounding Reference Signal (SRS) on the uplink on either a specific frequency or over the entire bandwidth, where the EUTRAN Node B (E-NB) receives the reference signal and performs channel estimates to calculate the beamforming characteristics. For example, the beamforming characteristics may be derived from a hypothesis so that the signals from different antenna elements are constructively combined at the UE. The Demodulation Reference Signal (DMRS) is another reference signal that is configured either on the UL or DL to find beamforming characteristics for transmitter and/or receiver beamforming.

While common channel beamforming uses static beamforming characteristics, which enables quick beamforming, such common channel beamforming is not directional or efficient. UE-specific beamforming, on the other hand, is more directional and efficient due to the use of reference signals, e.g., SRS or DMRS, for dynamically determining beamforming characteristics, but causes a delay before the beams can actually be formed, particularly in handover or dual connectivity scenarios. Thus, there remains a need for improved beamforming solutions.

### SUMMARY

The solution presented herein reuses beamforming characteristics used to form the beam(s) for one Radio Access Technology (RAT) when forming beam(s) for a different RAT becomes desirable, e.g., during handover or for dual connectivity scenarios, when an antenna arrangement for the first RAT is close enough to the antenna arrangement for the second RAT. When these antenna arrangements are “close enough,” the assumption is that the beamforming characteristics for the first RAT are a reasonable approximation of the beamforming characteristics that would be determined for the second RAT. By reusing the beamforming characteristics, the solution presented herein provides the efficiency and directionality provided by dynamic beamforming while avoiding the delay typically associated with traditional dynamic beamforming solutions.

One exemplary embodiment provides a method of wireless communication between a wireless terminal and a radio network. The method comprises forming a first beam according to first beamforming characteristics for wireless communications between the wireless terminal and the radio network using a first RAT. The method further comprises determining to implement wireless communications between the wireless terminal and the radio network using a second RAT, different from the first RAT. When a first antenna arrangement in the radio network associated with the first RAT is colocated with a second antenna arrangement in the radio network associated with the second RAT, the method further comprises forming a second beam according to the first beamforming characteristics for the wireless communications between the wireless terminal and the radio network using the second RAT.

One exemplary embodiment comprises a computer program product for controlling a transceiver for implementing wireless communications between a wireless terminal and a radio network. The computer program product comprises software instructions which, when run on at least one processing circuit in the transceiver, causes the transceiver to form a first beam according to first beamforming characteristics for wireless communications between the wireless terminal and the radio network using a first RAT. The software instructions, when run on at least one processing circuit in the transceiver, further causes the transceiver to determine to implement wireless communications between the wireless terminal and the radio network using a second RAT, different from the first RAT. When a first antenna arrangement in the radio network associated with the first RAT is colocated with a second antenna arrangement in the radio network associated with the second RAT, the software instructions, when run on at least one processing circuit in the transceiver, further causes the transceiver to form a second beam according to the first beamforming characteristics for the wireless communications between the wireless terminal and the radio network using the second RAT.

One exemplary embodiment comprises an apparatus for carrying out the method disclosed herein.

One exemplary embodiment comprises a network node comprising one or more transceivers configured to carry out the method disclosed herein.

One exemplary embodiment comprises a transceiver for implementing wireless communications between a wireless terminal and a radio network. The transceiver comprises a beamforming circuit and a processing circuit. The beamforming circuit is configured to form a first beam according to first beamforming characteristics for wireless communications between the wireless terminal and the radio network using a first RAT. The processing circuit is configured to determine to implement wireless communications between the wireless terminal and the radio network using a second RAT, different from the first RAT. When a first antenna arrangement in the radio network associated with the first RAT is colocated with a second antenna arrangement in the radio network associated with the second RAT, the beamforming circuit is further configured to form a second beam according to the first beamforming characteristics for the wireless communications between the wireless terminal and the radio network using the second RAT.

The methods disclosed herein may be implemented by the radio network and/or the wireless terminal, where both antenna arrangements are part of the radio network. Further, the transceiver disclosed herein may be implemented in the radio network and/or in the wireless terminal. In some embodiments, the colocation may be defined by the physical location of the antenna arrangements, e.g., when the second antenna arrangement is integrated with the first antenna arrangement in the same network node or when the physical distance separating the first and second antenna arrangements is less than a threshold distance. In other embodiments, the colocation may be defined from historical data, i.e., data from past use of the second RAT indicating that the beamforming characteristics ultimately determined for the second RAT were similar (or similar enough) to those determined for the first RAT.

### BRIEF DESCRIPTION OF THE DRAWINGS

FIGS. 1 and 2 show exemplary wireless networks applicable for the solution presented herein.

FIG. 3 shows an exemplary split mode architecture.

FIG. 4 shows a method according to exemplary embodiments of the solution presented herein.

FIG. 5 shows transceivers according to exemplary embodiments of the solution presented herein.

FIG. 6 shows exemplary antenna arrangements applicable for the solution presented herein.

FIG. 7 shows exemplary angles of arrival for different antenna arrangements.

FIG. 8 shows exemplary handover applicable for the solution presented herein.

FIG. 9 shows exemplary wireless network connectivity applicable for the solution presented herein.

FIG. 10 shows an exemplary method specific to the network node according to the solution presented herein.

FIG. 11 shows an exemplary method specific to the wireless terminal according to the solution presented herein.

### DETAILED DESCRIPTION

When conventional UE-specific beamforming, or any other dynamic beamforming solution, is used for wireless communications, a beamforming procedure is first performed to determine the beamforming characteristics used to form the beams. For example, a procedure using reference signals, e.g., a Sounding Reference Signal (SRS) or a Demodulation Reference Signal (DMRS), may be implemented to determine the beamforming characteristics. Such procedures involve signaling overhead. Conventional beamforming solutions apply common channel beamforming to UE-specific control and data channels when switching from one antenna arrangement to another, e.g., when switching from one RAT to another, by using common channel beamforming. Because common channel beams are wide area beams that rely on static beamforming characteristics, which do not consider any of the current channel conditions or network load, common channel beams are not directional or efficient.

The solution presented herein addresses these issues by identifying circumstances where previously determined beamforming characteristics can be reused for a different antenna arrangement/RAT. Before discussing the solution presented herein, the following first provides general information regarding exemplary wireless communication networks/scenarios applicable to the solution presented herein.

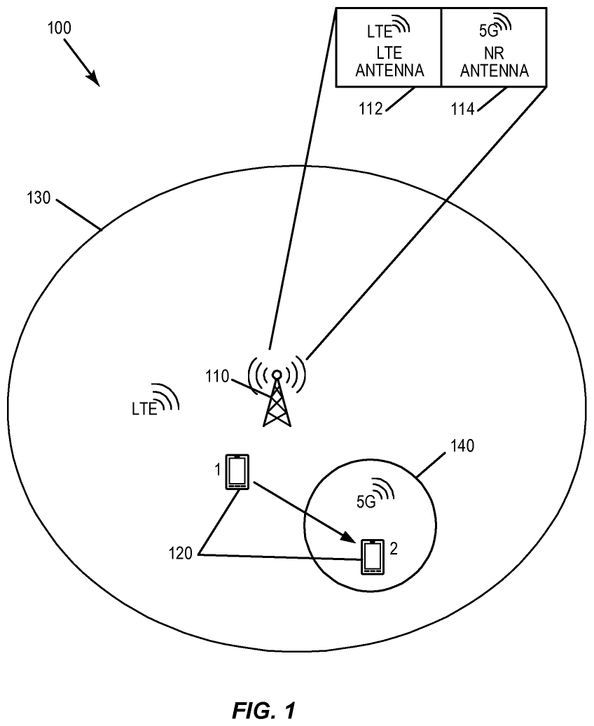

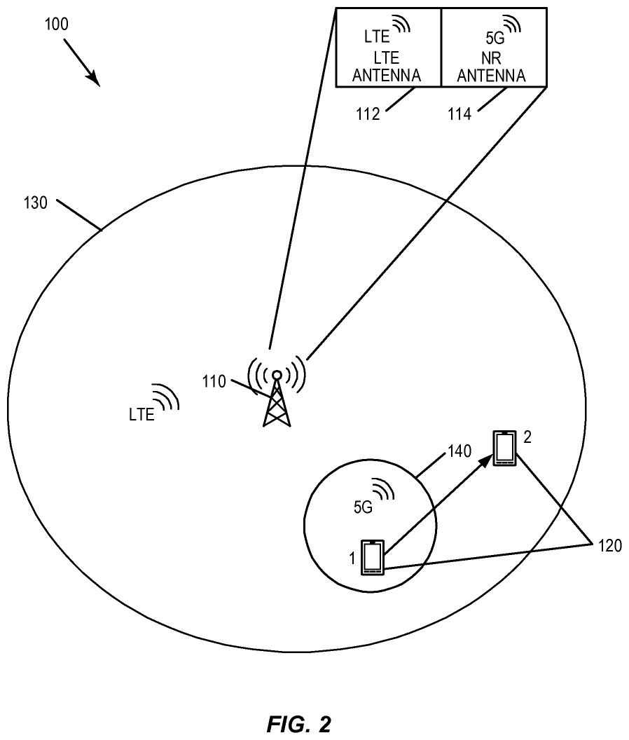

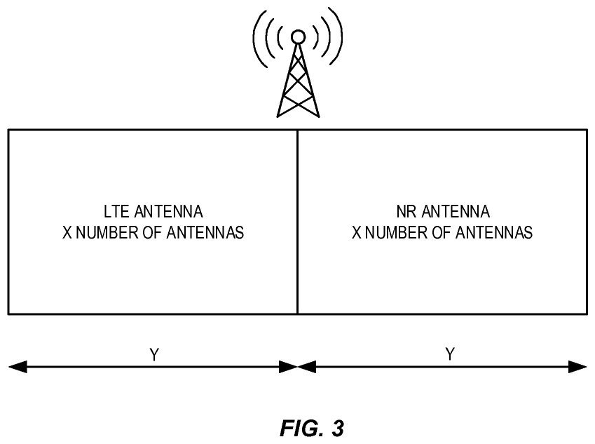

FIGS. 1 and 2 show an exemplary wireless communications network 100 suitable for wireless communications between a network node 110 and a wireless terminal 120. As shown in FIGS. 1 and 2, the network node 110 has been configured to implement wireless communications according to at least two different RATs, e.g., LTE and NR, where in this scenario, the antenna arrangements 112, 114 for the different RATs are integrated onto the same network node 110. In some embodiments, “integrated onto the same network node” may refer to a split mode architecture, where the antenna arrangements for the different RATs are part of the same antenna panel belonging to a radio and/or a network node, as shown in FIG. 3.

In FIG. 1, the wireless terminal 120 in the LTE coverage area 130 moves into the NR coverage area 140, while in FIG. 2, the wireless terminal 120 moves out of the NR coverage area 140. In either case, the transition results in the forming of new beams for the new RAT, either because the wireless terminal 120 is being handed over to the new RAT (e.g., FIG. 1 and/or FIG. 2), or because dual connectivity that includes the new RAT will improve wireless communications between the network node 110 and the wireless terminal 120 (e.g., FIG. 1). As such, a transceiver in the network node 110 and/or in the wireless terminal 120 determines beamforming characteristics for the RAT being transitioned into.

To avoid the delay and efficiency issues of conventional beamforming techniques, the solution presented herein reuses beamforming characteristics determined for a first/master RAT to form beams for a different second/secondary RAT when conditions are such that the beamforming characteristics determined for the first RAT are expected to be sufficient for the second RAT. This reuse may occur any time non-static beamforming characteristics are otherwise not available for the second RAT, e.g., upon initial access during handover or dual connectivity scenarios, when measuring the signal strength on the secondary RAT for, e.g., periodic or event driven measurement reports, etc. For example, the solution presented herein reuses the LTE beamforming characteristics to form beams for the NR wireless communications when the wireless terminal 120 moves from the LTE coverage area 130 to the NR coverage area 140, as shown in FIG. 1. In another example, the solution presented herein reuses the NR beamforming characteristics to form beams for the LTE wireless communications when the wireless terminal 120 moves from the NR coverage area 140 to the LTE coverage area 130, as shown in FIG. 2. It will be appreciated that the beamforming characteristics may be reused for the transmission beams and/or the reception beams.

The solution presented herein interchangeably refers to the different RATs as first or master RAT, and as second or secondary RAT. As presented herein, the first RAT refers to either LTE or NR, and the second RAT refers to the other of LTE and NR. It will be appreciated, however, that the solution presented herein may be applied to other radio access technologies than LTE and NR, particularly any RATs that having similar or the same frequency ranges and/or using closely proximate antenna arrangements. It will further be appreciated that the solution presented herein applies to scenarios involving two or more RATs, not just the two RAT scenarios used to describe the solution.

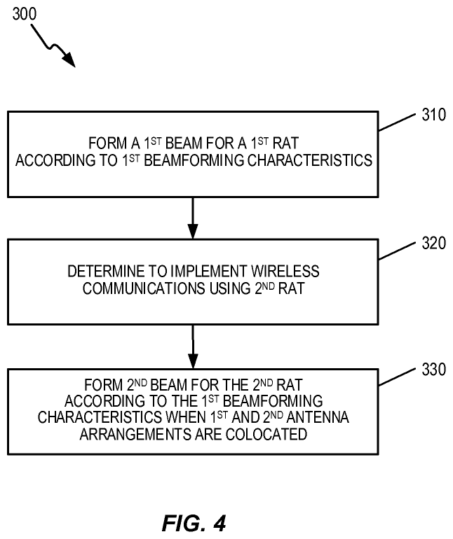

FIG. 4 shows an exemplary method 300 according to the solution presented herein, which may be implemented by a network node 110 and/or a wireless terminal 120. Method 300 comprises forming a first beam according to first beamforming characteristics for wireless communications between the wireless terminal 120 and the radio network using a first (e.g., master) RAT (block 310), and determining to implement wireless communications between the wireless terminal 120 and the radio network using a second (e.g., secondary) RAT, different from the first RAT (block 320). When a first antenna arrangement in the radio network associated with the first RAT is colocated with a second antenna arrangement in the radio network associated with the secondary RAT, the method 300 further comprises forming a second beam according to the first beamforming characteristics for the wireless communications between the wireless terminal 120 and the radio network using the secondary RAT (block 330). By reusing the beamforming characteristics determined for the first RAT to form beams for the secondary RAT, the solution presented herein eliminates the delay associated with conventional dynamic beamforming implementations, i.e., conventional UE-specific beamforming, while simultaneously eliminating many of the efficiency and directionality/accuracy issues associated with static beamforming implementations, i.e., common channel beamforming.

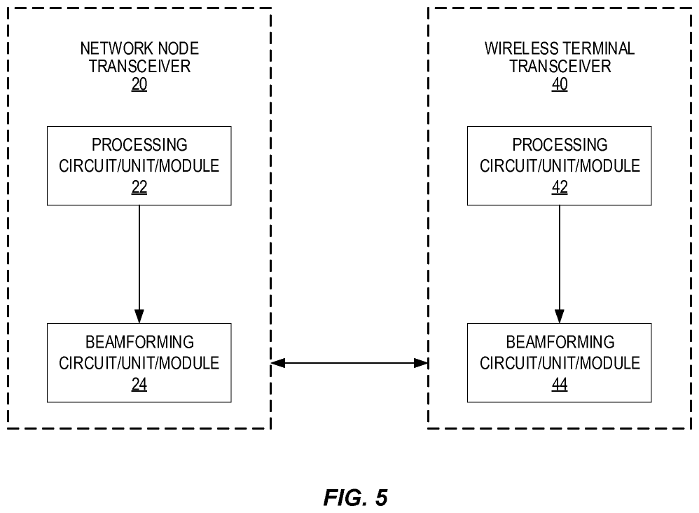

Method 300 may be implemented by any wireless transceiver that implements beamforming for one or more RATs. FIG. 5 shows exemplary transceivers, including a network node wireless transceiver 20 used to transmit/receive wireless signals to/from a wireless terminal 120, and a wireless terminal transceiver 40 used to transmit/receive wireless signals to/from a network node 110. Both transceivers 20, 40 include a processing circuit 22, 42 and a beamforming circuit 24, 44. The beamforming circuit 24, 44 is configured to form a first beam according to first beamforming characteristics for wireless communications between the wireless terminal 11- and the radio network using the master RAT. The processing circuit 22, 42 is configured to determine to implement wireless communications between the wireless terminal 120 and the radio network using a secondary RAT, different from the master RAT. The beamforming circuit 24, 44 is further configured to, when a first antenna arrangement in the radio network associated with the master RAT is colocated with a second antenna arrangement in the radio network associated with the secondary RAT, form a second beam according to the first beamforming characteristics for the wireless communications between the wireless terminal 120 and the radio network using the secondary RAT. While each of the apparatus elements in FIG. 5 show one transceiver, it will be appreciated that the solution presented herein may be implemented by multiple transceivers, e.g., one or more network node transceivers.

The transceiver 20, 40 may define and/or determine the colocation of the antenna arrangements in any number of ways. In one embodiment, the antenna arrangement for the master RAT is considered colocated with the antenna arrangement for the secondary RAT when both antenna arrangements are integrated within the same network node 110.

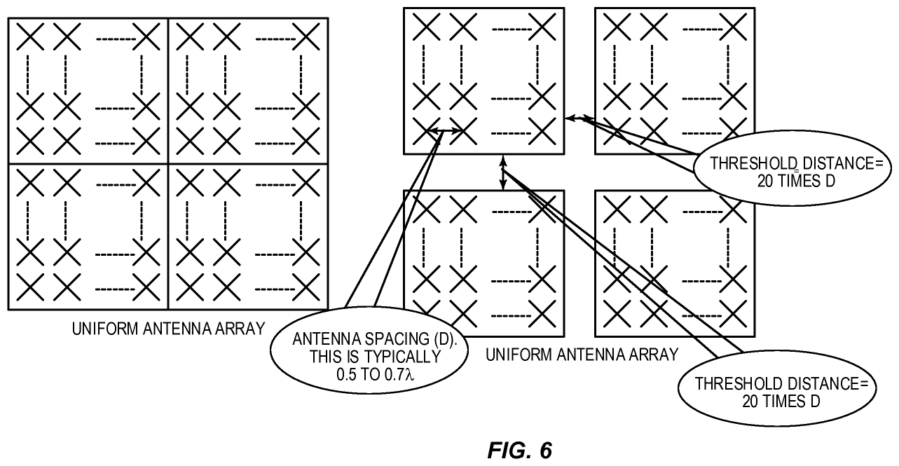

In another embodiment, the antenna arrangement for the master RAT is considered colocated with the antenna arrangement for the secondary RAT when the physical distance separating the two antenna arrangements, which is static, is small enough, e.g., less than a threshold distance. Exemplary threshold distances may be defined based on a center frequency associated with the master RAT or the secondary RAT (e.g., ten times the wavelength of the center frequency), based on the physical spacing between adjacent antenna elements of one of the antenna arrangements (e.g., twenty times the physical spacing between adjacent antenna elements), and/or based on a quality of a channel between one antenna arrangement and the wireless terminal 120. See FIG. 6, for example, which shows a multi-panel antenna arrangement relative to a uniform antenna arrangement, as well as exemplary threshold distances relative to the physical spacing between adjacent antenna elements.

In yet another embodiment, the antenna arrangement for the master RAT is assumed colocated with the antenna arrangement for the secondary RAT when historical data indicates both antenna arrangements use similar beamforming characteristics under similar conditions. For example, historical data may indicate previous handovers from the master RAT to the secondary RAT resulted in the secondary RAT determining beamforming characteristics for the secondary RAT that were similar or identical to the beamforming characteristics used for the master RAT before handover. In such cases, the historical data indicates that reuse would be beneficial, and thus that the two RATs may be considered colocated. Exemplary historical data indicating colocation may include the determined beamforming characteristics for the secondary RAT being nearly identical to, or offset by a small constant relative to, the beamforming characteristics used for the master RAT before handover. Alternatively or additionally, exemplary historical data indicating colocation may include data indicating that a difference in beam quality (e.g., as indicated by signal-to-noise ratio, antenna gain, etc.) between the master RAT beams and the secondary RAT beams, both of which are formed using the first beamforming characteristics, is below a threshold.

When the transceiver 20 is part of a network node 110, the transceiver 20 may know that the antenna arrangements are integrated within that network node 110 and/or may know the physical distance between the antenna arrangements, which is static, and thus knows whether the antenna arrangements are colocated. In other embodiments, the network node transceiver 20 may only know the physical location of one of the antenna arrangements, and thus may need to determine the location of the other RAT's antenna arrangement to determine whether the antenna arrangements are colocated, e.g., using geographical coordinates associated with a cell identifier and/or a global network identifier.

When the transceiver 40 is part of the wireless terminal 120, the transceiver 40 knows its antenna arrangements are colocated, but must obtain information from the network node 110 to determine whether the antenna arrangements at the network node 110 are colocated. For example, transceiver 40 may receive geographical coordinates for the antenna arrangements from the network node 110, or may determine the physical distance separating the two antenna arrangements from geographical coordinates associated with a cell identifier or a global network identifier. Transceiver 40 may alternatively receive a colocation indication from the network node 110 that the antenna arrangements are colocated. In another example, the transceiver 40 may use historical information as discussed above with respect to the network node 110 to determine whether the antenna arrangements are colocated, or may make the colocation determination responsive to timing advance information received from the network node 110. Alternatively, transceiver 40 may make determine the network node antenna arrangements are colocated if the network node 110 sends the wireless terminal 120 beamforming characteristics that are identical, or nearly identical, to those used for the master RAT.

It will be appreciated that other factors may be additionally considered when determining whether to reuse beamforming characteristics. For example, the beam formed for the master RAT may have a first channel bandwidth with a first center frequency f₁, and the beam formed for a secondary RAT may have a second channel bandwidth with a second center frequency f₂. In some embodiments, the reuse of one RAT's beamforming characteristics for another RAT may further depend on the frequency separation between f₁ and f₂. For example, a frequency separation less than a frequency threshold provides a further indication of the suitability of reusing the beamforming characteristics, where the frequency threshold may, e.g., be determined based on the cell bandwidth. For example, LTE cells have a 20 MHz bandwidth, where an LTE node comprises three cells, and thus has a 60 MHz bandwidth. In this example, an exemplary frequency threshold may be 65 MHz. In examples where the different RATs use the same part of the frequency spectrum, typically referred to as dynamic spectrum sharing, the beamforming characteristics for the first beam may be directly reused for forming the second beam, or may be extrapolated, e.g., based on a frequency difference. It will be appreciated that the transceivers 20, 40 know the center frequencies for the different RATs, and thus know the difference between the center frequencies. The transceivers 20, 40 may use this information to further determine whether to reuse the beamforming characteristics.

It will be appreciated that any beamforming characteristics are applicable for the solution presented herein. Exemplary beamforming characteristics include but are not limited to:
one or more beamforming weights applied to one or more corresponding antenna elements; and/or
an index to a grid-of-beams setup; and/or
an index to a code book used for codebook-based beamforming; and/or
one or more precoder weights for one or more streams; and/or
an Angle of Arrival (AoA) of the first beam.

For example, a first beam for a master RAT may be formed by applying a first plurality of beamforming weights to the respective antenna elements of the corresponding antenna arrangement of the master RAT. In this example, the beamforming characteristics may be reused to form the second beam for the secondary RAT by applying the same first plurality of beamforming weights to corresponding antenna elements of the antenna arrangement of the secondary RAT.

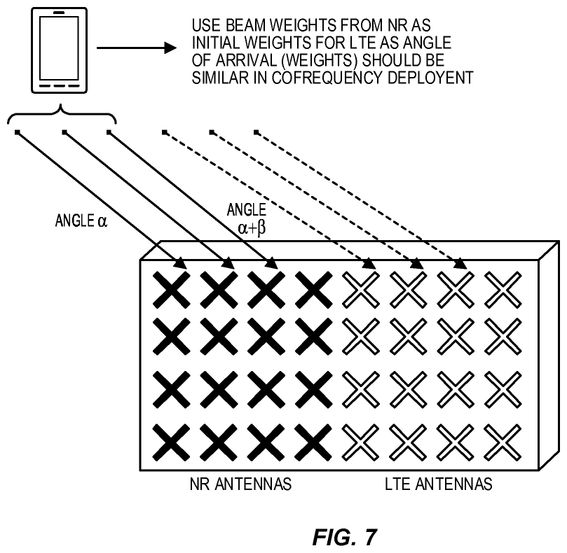

It will be appreciated that the reuse of the beamforming characteristics according to the solution presented herein includes directly reusing the same beamforming characteristics, as well as compensating the beamforming characteristics used to form beams for the master RAT to determine modified beamforming characteristics used to form beams for the secondary RAT, e.g., based on a distance, e.g., a physical distance, between the antenna arrangements for the master and secondary RATs, and/or based on a frequency difference. For example, a compensation may be applied to the beamforming weights used for the master RAT to determine modified beamforming weights to be used for the secondary RAT. Because the beamforming weights are frequency specific, the modified beamforming weights may be derived based on the frequency difference between f₁ and f₂. Similarly, as shown in FIG. 7, a compensation may be applied to the angle of arrival used to form the beams for the master RAT to determine a modified angle of arrival for the secondary RAT. It will also be appreciated that the reuse disclosed herein includes direct reuse of some beamforming characteristics, e.g., an index to a grid-of-beams setup, and the compensation of other beamforming characteristics, e.g., beamforming weights, to provide the beamforming characteristics used to form the beams for the secondary RAT.

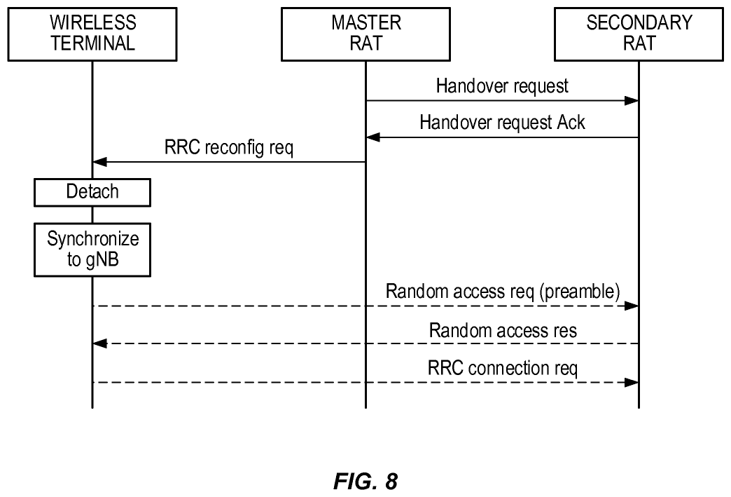

The beamforming characteristics may be reused indefinitely, or until the transceiver 20, 40 executes the reference signal procedure to more specifically determine the beamforming characteristics for the new RAT. FIG. 8 shows exemplary signaling for handover of the wireless terminal 120 from a master RAT to a secondary RAT, where the dashed lines represent the signaling that may benefit from the reuse disclosed herein. It will be appreciated that similar preamble, response, and connection request signaling for dual connectivity scenarios will also benefit from the reuse disclosed herein.

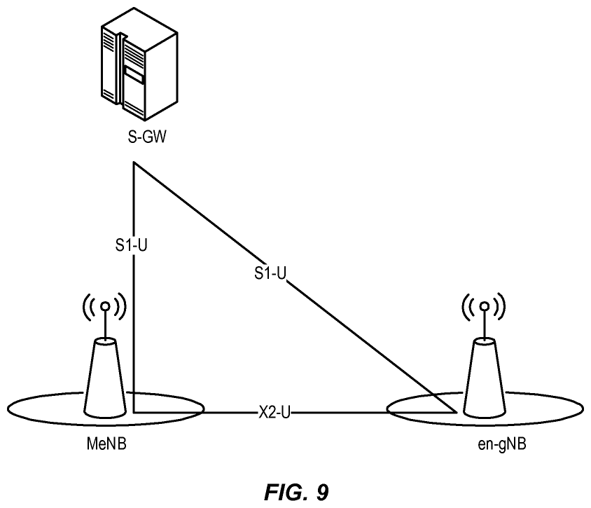

The solution presented herein is described in terms of first and second RATs, or master and secondary RATs. It will be appreciated that the solution presented herein involves the reuse of beamforming characteristic when forming different beams for different RATs. Exemplary RATs include LTE and NR (5G) RATs. It will be appreciated, however, that the solution presented herein applies to any different RATs that may be involved in handover or dual connectivity. In scenarios where the master and secondary RATs are part of different network nodes, the master RAT may send the beamforming characteristics to the secondary RAT, e.g., via an X2-U interface, as shown in FIG. 9.

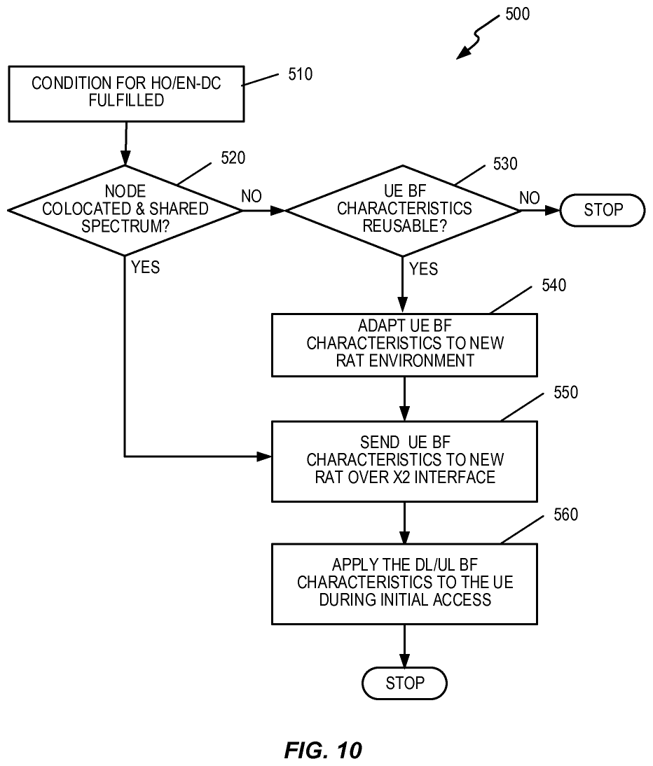

FIG. 10 shows an exemplary method 500 implemented by the network node 110 according to the solution presented herein. The method 500 comprises the network node 110 determining whether a condition for establishing a connection with a secondary RAT is fulfilled, e.g., determining whether a condition for handover to the secondary RAT or dual connectivity with the secondary RAT is fulfilled (block 510). If the network node 110 determines the network node antenna arrangements are not colocated (block 520), the network node 110 determines if the wireless terminal beamforming characteristics are reusable (block 530). For example, the network node 110 determines to reuse the beamforming characteristics if the frequencies are adjacent enough, e.g., separated by less than a frequency threshold.

If the wireless terminal beamforming characteristics are not reusable (block 530), the network node 110 adapts the wireless terminal beamforming characteristics to the new RAT (block 540). The network node 110 then sends the wireless terminal beamforming characteristics, either the adapted ones from block 540 or the original ones if the network node 110 determines the network node antenna arrangements are colocated (block 520), to the new RAT over an X2 interface (block 550), and applies the downlink/uplink beamforming characteristics to the wireless terminal 120 during initial access (block 560). It will be appreciated that method 500 is exemplary, and not limiting.

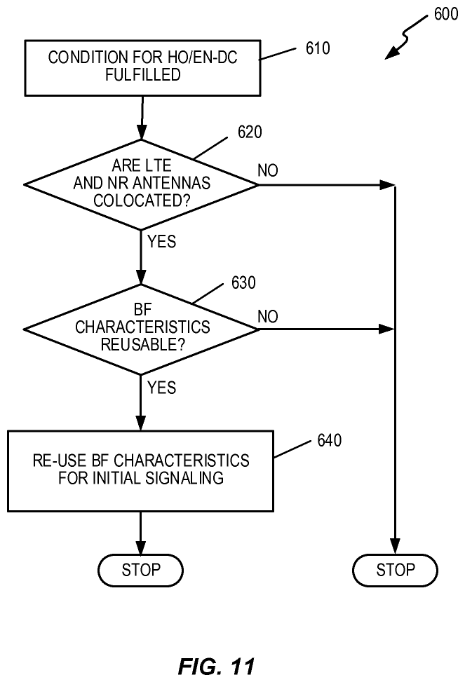

FIG. 11 shows an exemplary method 600 implemented by the wireless terminal 120 according to the solution presented herein. Once the wireless terminal 120 determines that a condition for handover/dual connectivity has been fulfilled (block 610), the wireless terminal 120 determines if the antenna arrangements at the network node 110 are colocated (block 620). If the antenna arrangements are colocated (block 620), the wireless terminal 120 may further determine if the beamforming characteristics are reusable, e.g., based on frequency considerations (block 630). When both conditions are satisfied, the wireless terminal 110 reuses the beamforming characteristics for initial signaling (block 640). It will be appreciated that method 600 is exemplary, and not limiting.

The solution presented herein has multiple advantages. For example, the reuse enables immediate use of dynamic beamforming characteristics, and thus reusing the beamforming characteristics as discussed herein will reduce interference, and thus improve the signal-to-noise ratio. Further, particularly when compared to conventional common channel beamforming, the solution presented herein improves the transmission and reception quality of UE-specific beamforming for the transition to the new RAT. In addition, the reuse disclosed herein reduces the time required to establish the connections with the new RAT, particularly for high load scenarios, where the reference signal measurements for each wireless terminal are less frequent. Further, the improved quality and efficiency of the beams formed using the solution presented herein will improve the handover success rate, which is an important Key Performance Indicator (KPI) for many providers.

As used herein, the term “wireless terminal” may include a cellular radiotelephone with or without a multi-line display; a Personal Communication System (PCS) terminal that may combine a cellular radiotelephone with data processing, facsimile, and data communications capabilities; a Personal Digital Assistant (PDA) that can include a radiotelephone, pager, Internet/intranet access, web browser, organizer, calendar, and/or a global positioning system (GPS) receiver; and a conventional laptop and/or palmtop receiver or other appliance that includes a radiotelephone transceiver. Wireless terminals may also be referred to as “pervasive computing” devices.

As used herein, “network node” refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network. Examples of network nodes include, but are not limited to, access points (APs) (e.g., radio access points), base stations (BSs) (e.g., radio base stations, Node Bs, evolved Node Bs (eNBs), and NR NodeBs (gNBs)). Base stations may be categorized based on the amount of coverage they provide (or, stated differently, their transmit power level) and may then also be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs. As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

Various elements disclosed herein are described as some kind of circuit, e.g., a beamforming circuit, a processing circuit, etc. Each of these circuits may be embodied in hardware and/or in software (including firmware, resident software, microcode, etc.) executed on a controller or processor, including an application specific integrated circuit (ASIC). Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

Furthermore, the present invention may take the form of a computer program product on a computer-usable or computer-readable storage medium having computer usable or computer-readable program code embodied in the medium for use by or in connection with an instruction execution system, where the processing circuit executes the code. In the context of this document, a computer-usable or computer-readable medium may be any medium that can contain, store, communicate, propagate, or transport the program for use by or in connection with the instruction execution system, apparatus, or device, and may comprise a non-transitory computer-readable medium. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, or a portable compact disc read-only memory (CD-ROM). Note that the computer-usable or computer-readable medium could even be paper or another suitable medium upon which the program is printed, as the program can be electronically captured via, for example, optical scanning or the paper or other medium, then compiled, interpreted, or otherwise processed in a suitable manner, if necessary, and then stored in a computer memory.

The solution present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

1-32. (canceled)

33. A method of wireless communication between a wireless terminal and a radio network, the method comprising:
forming a first beam according to first beamforming characteristics for wireless communications between the wireless terminal and the radio network using a first Radio Access Technology (RAT);
determining to implement wireless communications between the wireless terminal and the radio network using a second RAT, different from the first RAT; and
forming, when a first antenna arrangement in the radio network associated with the first RAT is colocated with a second antenna arrangement in the radio network associated with the second RAT, a second beam according to the first beamforming characteristics for the wireless communications between the wireless terminal and the radio network using the second RAT.

34. The method of claim 33:
wherein the method is implemented by a network node in the radio network;
wherein the forming the second beam according to the first beamforming characteristics comprises forming the second beam according to the first beamforming characteristics when the first antenna arrangement is integrated with the second antenna arrangement in the network node of the radio network.

35. The method of claim 34, wherein the forming the second beam according to the first beamforming characteristics comprises forming the second beam according to the first beamforming characteristics when a distance between the first antenna arrangement in the radio network and the second antenna arrangement in the radio network is less than a threshold distance.

36. The method of claim 35, wherein the threshold distance is associated with a quality of a channel between the first antenna arrangement and the wireless terminal.

37. The method of claim 35, wherein the threshold distance is defined based on a center frequency of the first beam and/or a center frequency of the second beam.

38. The method of claim 35, wherein the threshold distance is less than or equal to twenty times a spacing between two adjacent antenna elements of the first antenna arrangement.

39. The method of claim 34, wherein the forming the first beam according to the first beamforming characteristics comprises applying a first plurality of beamforming weights to a respective plurality of antenna elements of the first antenna arrangement.

40. The method of claim 39, wherein the forming the second beam according to the first beamforming characteristics comprises applying the first plurality of beamforming weights to a respective plurality of antenna elements of the second antenna arrangement.

41. The method of claim 33, wherein the method is implemented by the wireless terminal.

42. The method of claim 41, further comprising determining whether the first and second antenna arrangements are colocated in the radio network responsive to geographical coordinates obtained from the radio network for each of the first and second antenna arrangements.

43. The method of claim 41, further comprising determining whether the first and second antenna arrangements are colocated in the radio network responsive to historical information associated with the first and second antenna arrangements.

44. The method of claim 41, further comprising determining whether the first and second antenna arrangements are colocated in the radio network responsive to timing advance information obtained from the radio network for each of the first and second antenna arrangements.

45. The method of claim 41, further comprising determining whether the first and second antenna arrangements are colocated in the radio network responsive to a colocation indication received from the radio network.

46. The method of claim 33:
wherein the first beam has a first channel bandwidth with a first center frequency; and
wherein the second beam has a second channel bandwidth with a second center frequency equal to the first center frequency.

47. The method of claim 33:
wherein the first beam has a first channel bandwidth with a first center frequency;
wherein the second beam has a second channel bandwidth with a second center frequency; and
wherein a difference between the first center frequency and the second center frequency is less than 65 MHz.

48. The method of claim 33, wherein the first beamforming characteristics comprise:
one or more beamforming weights applied to one or more corresponding antenna elements; and/or
an index to a grid-of-beams setup; and/or
an index to a code book used for codebook-based beamforming; and/or
one or more precoder weights for one or more streams; and/or
an Angle of Arrival (AoA) of the first beam.

49. The method of claim 33, wherein the forming the second beam according to the first beamforming characteristics comprises:
applying a compensation to the first beamforming characteristics when the first antenna arrangement is colocated with the second antenna arrangement to generate modified beamforming characteristics, the compensation derived from a distance between the first antenna arrangement in the radio network and the second antenna arrangement in the radio network; and
forming the second beam according to the modified beamforming characteristics for the wireless communications between the wireless terminal and the radio network using the second RAT.

50. The method of claim 33, wherein one of the first and second RATs comprises a Long-Term Evolution (LTE) RAT and the other of the first and second RATs comprises a New Radio (NR) RAT.

51. An apparatus for wireless communication between a wireless terminal and a radio network, the apparatus comprising:
a beamforming circuit;
processing circuitry operatively connected to the beamforming circuit;
memory containing instructions executable by the processing circuitry whereby the apparatus is operative to:
form a first beam according to first beamforming characteristics for wireless communications between the wireless terminal and the radio network using a first Radio Access Technology (RAT);
determine to implement wireless communications between the wireless terminal and the radio network using a second RAT, different from the first RAT; and
form, when a first antenna arrangement in the radio network associated with the first RAT is colocated with a second antenna arrangement in the radio network associated with the second RAT, a second beam according to the first beamforming characteristics for the wireless communications between the wireless terminal and the radio network using the second RAT.

52. A network node for wireless communication between a wireless terminal and a radio network, the network node comprising:
one or more transceivers, the one or more transceivers configured to:
form a first beam according to first beamforming characteristics for wireless communications between the wireless terminal and the radio network using a first Radio Access Technology (RAT);
determine to implement wireless communications between the wireless terminal and the radio network using a second RAT, different from the first RAT; and
form, when a first antenna arrangement in the radio network associated with the first RAT is colocated with a second antenna arrangement in the radio network associated with the second RAT, a second beam according to the first beamforming characteristics for the wireless communications between the wireless terminal and the radio network using the second RAT.
